(19) United States
(12) Patent Application Publication
(10) Pub. No.: US 2015/0033246 A1
(43) Pub. Date: Jan. 29, 2015

(54) PASSIVE DEMOGRAPHIC MEASUREMENT APPARATUS

(71) Applicant: Atlas Advisory Partners, LLC, Hoboken, NJ (US)

(72) Inventors: Richard E. Gideon, Hoboken, NJ (US); Marie Jannone, Hoboken, NJ (US)

(21) Appl. No.: 14/453,293

(22) Filed: Aug. 6, 2014

Related U.S. Application Data
(63) Continuation of application No. 13/190,616, filed on Jul. 26, 2011, now abandoned.
(60) Provisional application No. 61/367,536, filed on Jul. 26, 2010.
(60) Provisional application No. 61/367,541, filed on Jul. 26, 2010.
(60) Provisional application No. 61/471,948, filed on Apr. 5, 2011.
(60) Provisional application No. 61/492,997, filed on Jun. 3, 2011.
(60) Provisional application No. 61/502,022, filed on Jun. 28, 2011.

(51) Int. Cl. H04N 21/258; H04N 21/658; H04N 21/4223; H04N 21/422

(52) U.S. Cl. CPC H04N 21/25883; H04N 21/422; H04N 21/6582; H04N 21/4223
USPC 725/12

(57) ABSTRACT

A passive demographic measurement apparatus, comprising an interface for coupling to a Microsoft Kinect®-type sensor, a network interface for sending information to remote device via a network, storage for storing information characteristic of sensed individuals and information sensed by the Kinect sensor, a clock for providing the time and duration of the sensed information, a messaging instruction storage storing instructions for use by the local device in sending data and messages to remote devices, an analysis engine for analyzing at least a portion of the sensed data, and a processor for processing raw and analyzed data for sending to a remote device and/or for sending a message to another device responsive to received sensed data.

### CROSS-REFERENCE TO RELATED APPLICATION

This application is a continuation of U.S. patent application Ser. No. 13/190,616, filed on Jul. 26, 2011, which claims the benefit of priority to U.S. Application Ser. No. 61/471,948, filed Apr. 5, 2011, entitled Passive Demographic Measurement Apparatus; U.S. Application Ser. No. 61/367,536, filed Jul. 26, 2010, entitled Passive Demographic Measurement Apparatus, and is related to U.S. Application Ser. No. 61/502,022, filed Jun. 28, 2011, entitled Unified Content Delivery Platform; U.S. Ser. No. 61/492,997, filed Jun. 3, 2011, entitled Unified Content Delivery Platform; U.S. Ser. No. 61/367,541, filed Jul. 26, 2010, entitled Unified Content Delivery Platform; each of which applications is incorporated herein by reference as if set forth herein its respective entirety.

### BACKGROUND

Microsoft's Kinect is a peripheral device which connects to an external interface of Microsoft's Xbox 360®. It senses, recognizes, and utilizes the user's anthropomorphic form so the user can interact with games and media content without the need for a separate controller. Kinect comprises an RGB camera, depth sensor, and multi-array microphone running proprietary software. The Kinect sensors recognize faces and links them with profiles stored on the device. It has the capability to track full-body movement and individual voices, so that each individual is recognized within the room in order to interact with games and content.

In particular, in its current configuration, the Kinect sensor unit comprises a horizontal bar connected to a small base with a motorized pivot, and is designed to be positioned lengthwise below a video display. The RGB camera enables facial recognition, for example. The depth sensor comprises an infrared projector combined with a monochrome CMOS sensor which can, for example, visualize a room in which the Kinect is situated in three dimensions under any lighting conditions. The multi-array microphone enables location of sound sources such as voices by acoustic source localization, and can suppress ambient noise. Microsoft provides a proprietary software layer to realize the Kinect's capabilities, for example, to enable human body recognition.

The Kinect is capable of simultaneously tracking a plurality of individuals. In its current configuration, the Kinect sensor outputs video at a frame rate of 30 Hz, with an RGB video stream at 32-bit color VGA resolution (640×480 pixels), and a monochrome video stream used for depth sensing at 16-bit QVGA resolution (320×240 pixels with 65,536 levels of sensitivity). As such, the Kinect sensor has a practical ranging limit of about 1.2-3.5 meters. The sensor has an angular field of view of 57° horizontally and a 43° vertically, while the motorized pivot is capable of tilting the sensor as much as 27° either up or down. The microphone array features four microphone modules, and operates with each channel processing 16-bit audio at a sampling rate of 16 kHz.

Microsoft introduced the Kinect at an event called the “World Premiere ‘Project Natal’ for the Xbox 360 Experience” at the Electronic Entertainment Expo 2010, on Jun. 13, 2010 in Los Angeles, Calif. The Kinect system software allows users to operate the Xbox 360 user interface using voice commands and hand gestures. Techniques such as voice recognition and facial recognition can be used for automatically identifying users. Provided software can use Kinect's tracking functionality and the Kinect sensor's motorized pivot to adjust the camera so that a user may be kept in frame even when moving.

It is desirable to incorporate aspects of the Kinect into novel non-gaming applications.

### SUMMARY

It is an aspect of the present invention to provide a passive demographic measurement device, such as by acquiring a data stream and making it available for other applications and for licensing. The data stream can comprise information of one or more individuals present in an area, such as their age, gender, their location, and the date and time they are at that location. Using such information, the data can be utilized in applications such as home security, and home healthcare, home automation, and media audience measurement.

The data stream may be associated with other data streams based on the date and time, and analyzed as desired. Such data gathering, combining, and analysis can provide rich demographic profiles, for example.

It is to be understood that both the foregoing general description and the following detailed description are exemplary and explanatory, and are intended to provide further explanation of the invention as claimed.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods.

FIG. 2 is a block diagram showing an exemplary networked computing environment for use in accordance with herein described systems and methods.

FIG. 3 is a flow diagram of an exemplary method for use in accordance with herein described systems.

FIG. 4 is a simplified block diagram showing an exemplary configuration in accordance with herein disclosed systems and methods.

FIG. 5 is a block diagram showing exemplary components of a local device in accordance with the herein disclosed systems and methods.

FIG. 6 is a simplified block diagram showing an exemplary configuration in accordance with herein disclosed systems and methods.

### DETAILED DESCRIPTION

The Kinect is an exemplary device of a type that may be used to determine who is in an area, and when they are there. This information may be used to measure audience demographics, for example. The age and gender of individuals in an area may be matched with stored profiles. In an exemplary embodiment, modifications to a system such as the Kinect system may be implemented.

For example, modifications to the software layer may be implemented so that only information of recognized individuals identified by their stored profiles, and their presence in the room, are obtained. Such an approach effectively filters out the presence of individuals that are not recognized or that do not have stored profile information. Movement is not required to gather such information, and privacy issues may be mitigated as a result.

One or more local devices, such as other than an Xbox 360 console, each including one or more functional components, may be used in conjunction with a device such as the Kinect sensor unit. In an implementation, the XBOX 360 console may be excluded entirely from the configuration.

Such local devices and/or components may include, but are not limited to, an input device or arrangement having a display, so that an identified individual may be notified her profile is registered and she has been recognized for measurement. The current date and time, and the duration of presence in the room, may also be entered and/or automatically determined and displayed.

If an individual is not recognized, that could indicate the presence of a visitor. The input device may allow the association of an unrecognized individual with an existing profile, or the entry of a new profile. A individual's profile comprises information of the individual, such as one or more attributes or characteristics of the individual, and may be stored in a machine-readable storage device such as a magnetic drive, optical drive, flash drive, or the like.

A network interface may be included for use in providing information to or obtaining information from remote devices, such as other Kinect systems, data storage devices, and data processing devices, for storing, combining, manipulating, and/or analyzing such information. The interface may provide a wired and/or wireless connection to the remote devices. In an embodiment, the local device may be used to communicate with a local central hub which can aggregate and process data gathered from a plurality of local devices and/or associated Kinect-type sensors, and the central hub may provide its data to a remote device.

In an embodiment, profile information such as the age and gender of identified individuals, and date and time information, can be communicated automatically by the local device to the local central hub, or directly to the remote device, upon identification of one or more individuals present in the room where the Kinect-type sensor associated with the local device is located. Upon the egress of such an identified individual from the room, the duration of that person's presence in the room can also be determined and communicated. Networks of various types or combinations of types can be used for such communications. For example, a local device associated with a Kinect-type sensor may communicate with a local central hub via a wired or wireless Ethernet connection, a Bluetooth connection, an infrared connection, or the like. Alternatively, the local device, and/or the local central hub, may communicate with a remote device using a cellular telephone connection, a wired dial-up connection over a POTS line, a fiber optic, copper wire, or coaxial cable connection to a network such as the Internet, or the like. The communication may be directly connected, such as via a circuit switched connection, or may be connectionless, such as via a packet switched connection.

In an exemplary operation, the Kinect-type data stream may be combined with cable and/or satellite set top box viewing measurements in order to provide information of the audience viewing a TV channel. The combined data can provide demographic information of viewers of a channel, and television audience estimates may be calculated based thereon.

In the prior art, cable and/or satellite set top box data may provide periodic measurements of viewing of a channel on the order of every few seconds. Accordingly, television program content and commercial occurrences measured at that level may include demographic data recorded at substantially the same time intervals. Aggregation and analysis of such measurements may provide insights of importance, for example, with regard to the placement of commercials within pods inserted into program content. Media research companies may be interested in such an application, and may include existing and future audience measurement companies such as, without limitation, The Nielsen Company, Arbitron, Rentrak, TNS, Canoe Ventures, Tivo, IPSOS, NAVIC, CIMM and TRA. Interested companies may also include cable multi-system operators (MS0s) and satellite distributors.

Moreover, demographic viewing data may be collected in connection with viewing that occurs through a local device, such as the XBOX, such as NetFlix video streaming and the like, for processing using the herein disclosed systems and methods.

In another exemplary operation, geographic information, obtained for example from cable or satellite system customer records, may be combined with demographic information obtained using the Kinect-type sensor. Such information may be used to target advertising campaigns to specific demographics and locations.

In another embodiment, the Kinect-type data stream may be combined with premises security and/or health systems. In an exemplary operation, one or more Kinect-type sensors may be used to detect the presence of unidentifiable individuals, possibly indicating the presence of an intruder or other unauthorized access. Accordingly, the Kinect-type data stream may be used to notify a security service, the police, and the like. Furthermore, the Kinect-type data stream may also be combined with data of health monitoring devices and the like to detect the mobility and health status of individuals in an area. For example, the Kinect-type sensor may detect an elderly person falling to the floor, and/or laying on the floor, and/or struggling to get up from the floor. A local device embodying the herein disclosed systems and methods may use such information to send an alert to a family member or other caregiver or monitoring service. An audible or visual alarm signal can also be initiated locally.

In yet another embodiment, the Kinect-type data stream may be used by a local device to send control signals to one or more home automation devices in response to the detection of an identified individual's presence, for example, to establish a preferred room ambience by implementing the individual's preferences for lighting, HVAC, music or other entertainment needs and the like. In an exemplary operation, the local device can combine the Kinect-type data stream with information obtained from the home automation devices to generate control signals, such as to modify existing settings of the home automation devices in changes in the identities and/or number of individuals identified as being present.

Reference will now be made in detail to various exemplary and illustrative embodiments of the present invention.

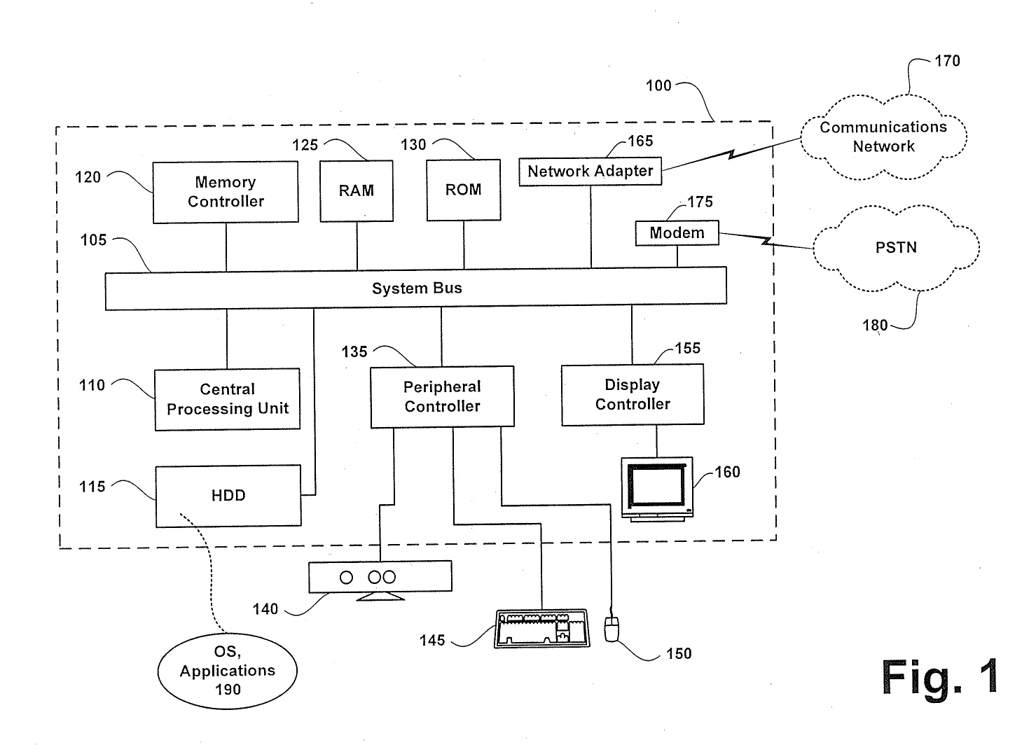

FIG. 1 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers (serdes) and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as Kinect-type sensor 140, keyboard 145, and mouse 150. For example, the peripherals may be removably coupled to the peripheral bus by coupling to a port, such as a universal serial bus (USB) port.

Display 160, which is controlled by display controller 155, can be used to display visual output generated by computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access to computing system 100 with means of communicating and transferring software and information electronically. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

Computing system 100 may also contain modem 175 which may be used to couple computing system 100 to a telephone communication network, such as the public switched telephone network (PSTN) 180. PSTN 180 may provide user access to computing system 100 via so-called Plain Old Telephone Service (POTS), Integrated Services Digital Network (ISDN), mobile telephones, Voice over Internet Protocol (VoIP), video telephones, and the like. It is appreciated that the modem connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

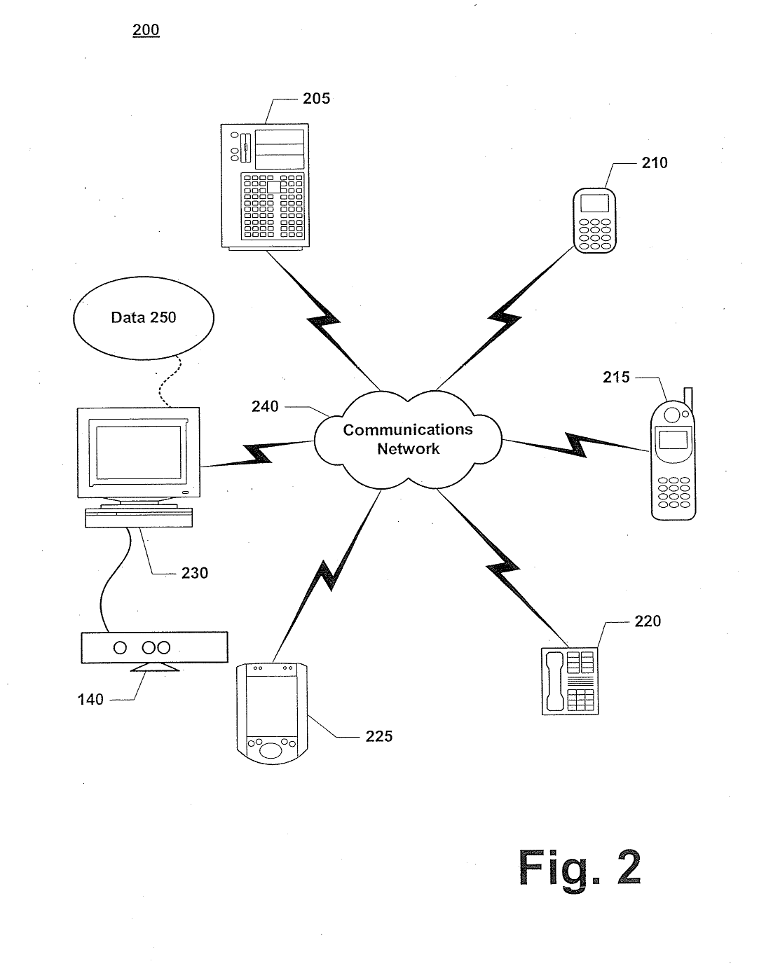

As shown in FIG. 2, computing system 100 can be deployed in networked computing environment 200. In general, the above description for computing system 100 applies to local devices associated with one or more Kinect-type sensors, and remote devices, such as aggregating and processing servers and the like. FIG. 2 illustrates an exemplary illustrative networked computing environment 200, with a local device coupled to a Kinect-type sensor in communication with other computing and/or communicating devices via a communications network, in which the herein described apparatus and methods may be employed.

As shown in FIG. 2, local device 230 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of other computing/communication devices such as server 205, beeper/pager 210, wireless mobile telephone 215, wired telephone 220, personal digital assistant 225, and/or other communication enabled devices (not shown). Local device 230 can comprise computing resources operable to process and communicate data such as digital content 250 to and from devices 205, 210, 215, 220, 225, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each device 205, 210, 215, 220, 225, etc. can be equipped with an operating system operable to support one or more computing and/or communication applications, such as a web browser (not shown), email (not shown), or the like, to interact with local device 230.

Local device 230 can store profile information of a plurality of individuals, such as residents of a home or employees of a business in which local device 230 resides. Local device is coupled to Kinect-type sensor 140, such as via a USB port, and receives sensed information from sensor 140. As described hereinbefore, local device 230 can store, aggregate, and analyze information received from sensor 140. Moreover, in an exemplary implementation, local device 230 can comprise a local hub that can communicate with a plurality of sensors 140. In addition, local device 230 can communicate with server 205 to provide or exchange information obtained by local device 230. Server 205 may be in communication with a plurality of local devices 230, and can store, aggregate, and analyze information received from any or all of them, in any desired manner, for use in the herein disclosed systems and methods.

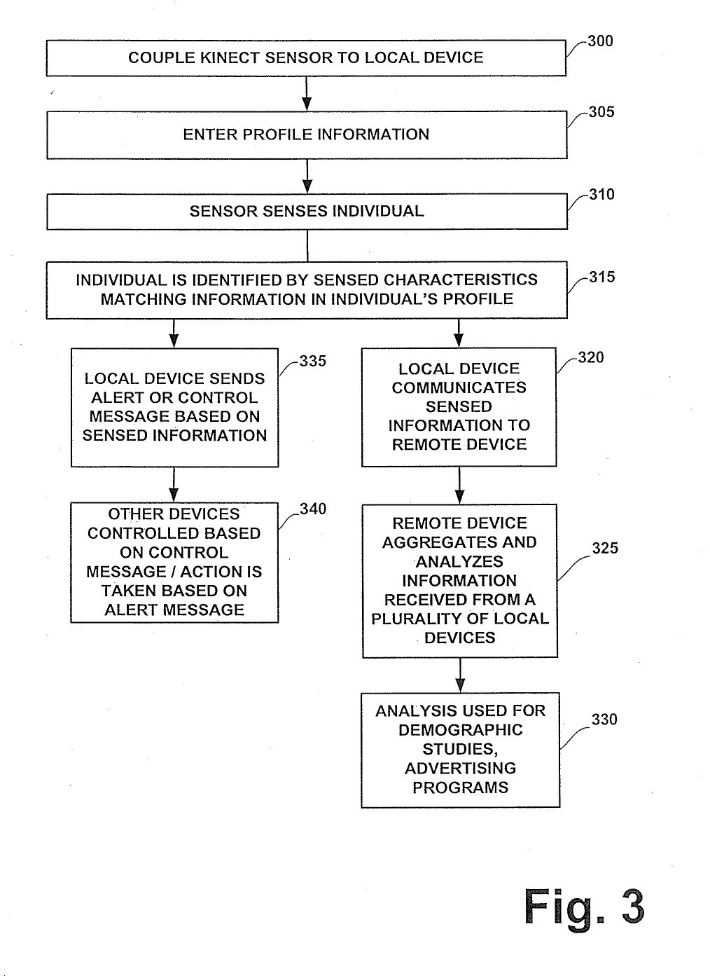

In FIG. 3, a Kinect-type sensor is coupled to a local device, step 300. Profile information is entered and associated with sensed characteristics of at least one individual, step 305. Thereafter, the individual is sensed when in range of the Kinect-type sensor, step 310 and identified using the stored profile information, step 315. The local device may send sensed information, or information based on the sensed data, to a remote device, step 320, where it is aggregated with data received from other local devices and analyzed in accordance with the herein disclosed methods and systems, step 325. The analysis can then be used in connection with demographic studies, targeted advertising, and the like, step 330.

Alternatively, or in addition, the local device can send an alert or a control message based on the sensed information, step 335. The control messages can control the operation of controllable devices, for example, at the premises where the local device is located, step 340. If an alerris sent, the alerted party can take an appropriate action, such as providing aid to an identified elderly person that the Kinect-type sensor has determined has fallen and can't get up, step, 340.

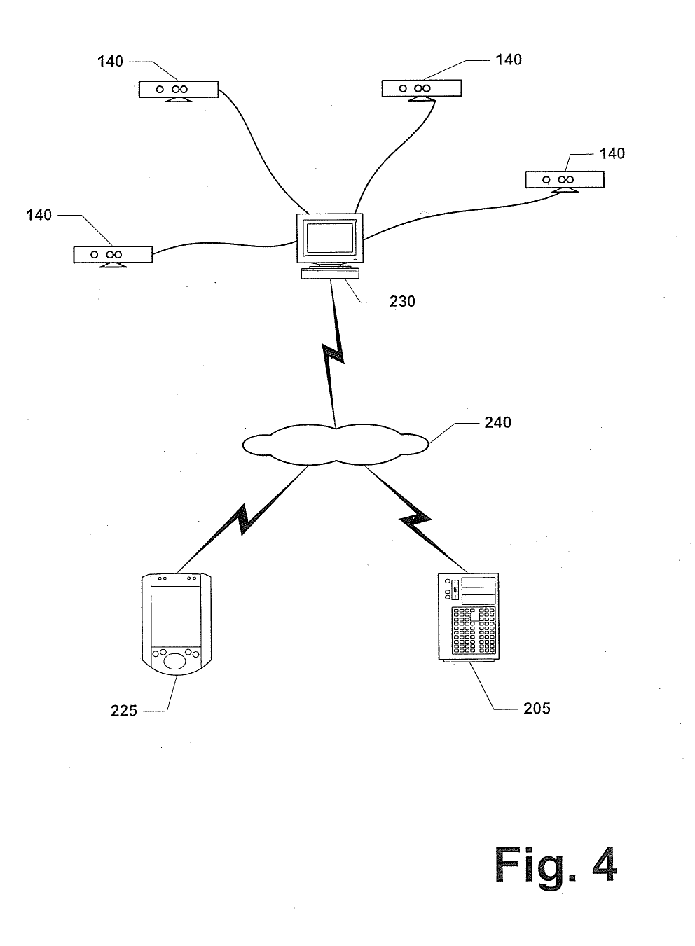

FIG. 4 is a simplified block diagram showing an exemplary configuration in accordance with herein disclosed systems and methods. A plurality of Kinect-type sensors 140 are deployed, for example, in different rooms of a house. Each of the sensors 140 is communicatively coupled to a central hub disposed in the house 230, which receives information from each of the sensors 140. In an exemplary operation, central hub 230 aggregates the received information and sends it to remote device 205, such as a remote computer, over network 240. Remote device 205 can receive similar information from a plurality if hubs (not shown), and aggregate and analyze the received information, for example, in accordance with herein disclosed systems and methods for use in a targeted advertising campaign. In another exemplary operation, central hub 230 sends control and/or alert messages. For example, hub 230 can send an alert message to personal digital assistant (PDA) 225 over network 240. The PDA may be carried by a caregiver, and the message may indicate that an elderly person under her care has fallen and needs attention.

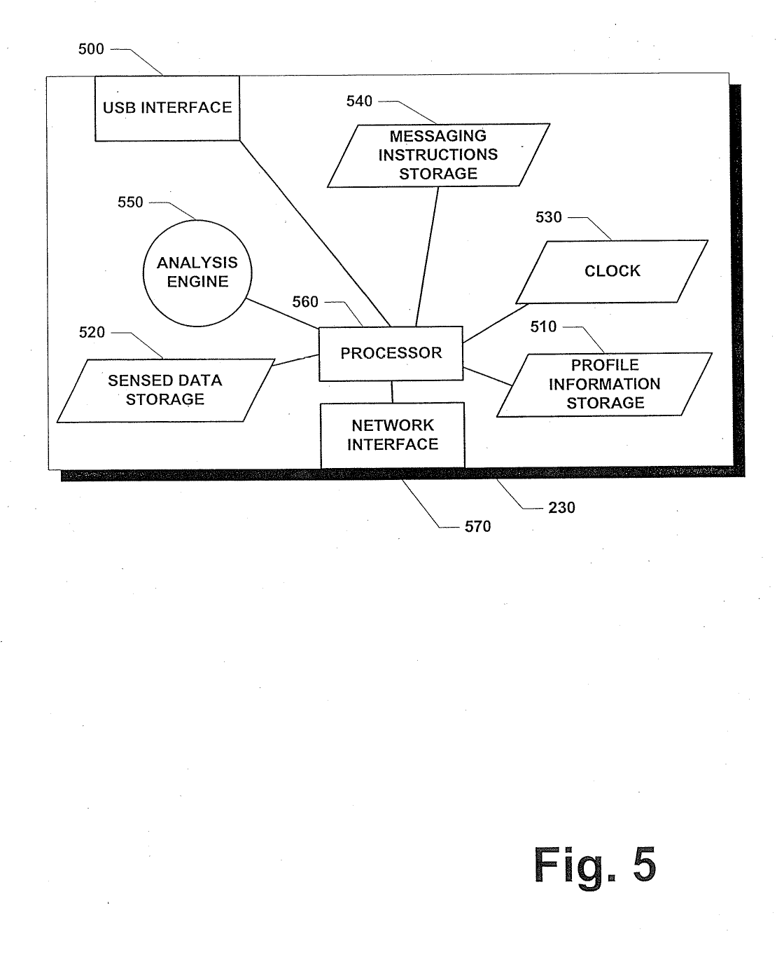

FIG. 5 is a block diagram showing exemplary components of a local device 230 in accordance with the herein disclosed systems and methods. Local device 230 comprises USB interface 500 for communicatively coupling to a Kinect-type sensor (not shown). Local device 230 also comprises profile information storage 510 for storing information of individuals that can be identified by the Kinect-type sensor. Local device 230 further comprises sensed data storage 520 for storing sensor information received from the Kinect-type sensor, and clock 530 for indicating the time and duration of sensed data. Local device further includes messaging instruction storage 540 for storing instructions regarding control and/or alert messages to be sent to other devices based on sensed data received. Analysis engine 550 can obtain information from profile storage 510, sensed data storage 520, clock 530, and/or messaging instruction storage 540, and analyze such information in accordance with the herein disclosed systems and methods. Processor 560 can then send raw or processed information, control messages, and/or alert messages to one or more remote devices via network interface 570.

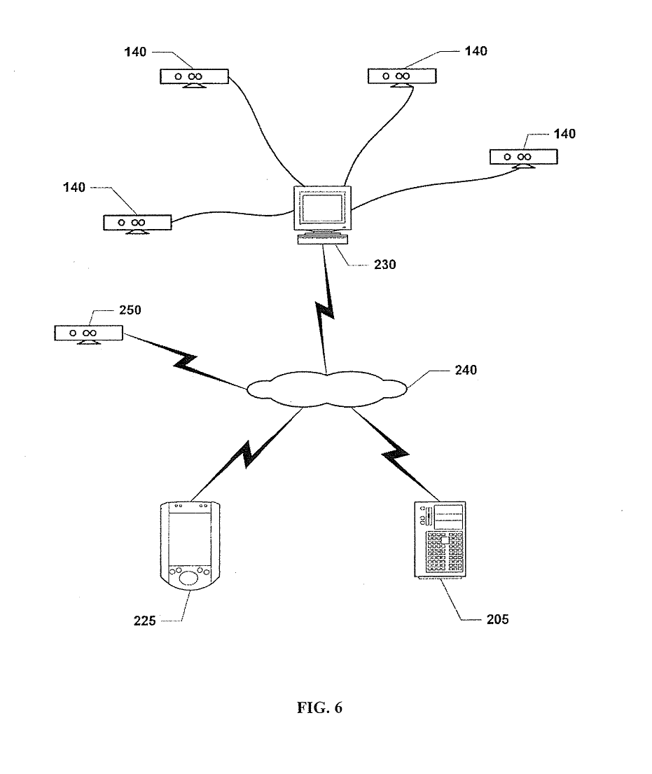

In an embodiment of the present invention, and with reference to FIGS. 5 and 6, a Kinect-type sensor 250 may be deployed as a remote device connected to the network 240. Such connection, as described herein, may be wireless and may allow remote device 250 to freely exist wherever a wireless connection may be obtained. The mobility of remote device 250 may enabled using any known mechanical device, such as, for example, a motorized track and/or wheel system. Such a system which may be implemented with the present invention is described in U.S. Pat. No. 6,779,621, issued on Aug. 24, 2004, which patent is incorporated herein by reference in its entirety.

Given the mobile nature of device 250, the operational functionality found in central hub 230 may also be encompassed in mobile device 250 as necessary. For example, mobile device 250 may have the ability to communicate with other sensors 140 as mobile device 250 moves around from room to room, for example. Such communication may allow for the wireless placement of sensors 140 in areas where communication access to central hub 230 is prohibited. Mobile device 250 may be enabled to facilitate communications directly from sensors 140 to remote device 205 over the network 204, for example, or may communicate directly to central hub 230. It is contemplated that if mobile device 250 is unable to establish contact with either central hub 230 and/or any other device via the network 240, information collected from the environment over which mobile device 250 has traveled and/or from one or more sensors 140, may be cached at remote device 250 until the desired communication link may be established.

In addition to the sensor capability provided with remote device 250, interactivity may be provided to facilitate interaction with a human user. Such an interactivity may take the form of a tablet computer, for example, and may provide the user with any number of applications and/or access to the central hub 230, network 240, and/or any other functions accessible through a tablet computer. For example, a user accessing a screen provided on mobile device 250 may access information and/or status of other sensors 140, may be provided access and control over central hub 230, and may be provided access to third party applications such as, for example, weather information, information and control over local and/or remote DERS, local appliances, automobiles, and/or social media for which the user may have access. As one skilled in the art would appreciate, the manner of the mobile device 250 to access any number of applications and/or functionalities given the integrated touch screen, CPU and interne conductivity, are innumerable.

As described, remote device 250 may be deployed in a house, such as a sentry, to increase the effective range of gathering sensitive information, at step 335. Additionally, the remote device 250 may be remotely controlled by a user such that a user may inspect property for which the mobile device 250 has access. In a homeowner situation, a user may log on into mobile device 250 via network 240 and remotely control the inspection to insure that the condition of the property is as expected. Similarly, such a device may be used in a commercial setting to patrol warehouses, parking garages, and other properties for which providing hard wire sensors 140 may be impractical. By way of example, an otherwise unpatrolled warehouse may be monitored and/or inspected by personnel attending to more than one warehouse, and/or by community officials who may be deployed into neighborhoods and/or other community spaces for which onsite human patrolis not practical.

Further, in an embodiment of the present invention, sensors 140 and remote sensor 250 may be employed to facilitate a mapping of the interior space of a structure, such as a home, for other purposes, for example. For example, an application may be employed by the user to assess the interior design of the space mapped by the present invention. Once an interior structure has been mapped and is rendered by an application resident at least partially on a central hub 230, a user may interact and may be provided with tools allowing for the virtual decorating of the mapped space. For example, a living room may be mapped and may be shown in a 3D rendering including wall color and texture, wall hangings, furniture and other objects common to a room. The rendered objects may then be manipulated through the application to allow the user of the application to create a room having the desired attributes and/or contents.

Such an application may allow a user to purchase items placed within the virtual rendering directly from a merchant, and/or may direct a user to one or more vendors who may be able to provide a given object or participate in any changes designated by the user which differ from the original sensed interior. Furthermore, as the user makes changes to the physical interior, the application may rely on the sensors of the present invention to update the virtual rendering and allow the user to see in real time the changes being made.

In a similar fashion, the sensors in the present invention may allow for the rendering of the user of the system. Such rendering may be 3D and may allow a user to change attributes about themselves and to have those attributes reported in real time. For example, an application may be provided which may allow for the viewing and/or purchasing of clothes for example. A user who has incorporated a virtual rendering of themselves into the system via the sensor 140 and/or remote device 250 may select from a provisioning of clothes which may be placed on their virtual 3D rendering to assess the look of the clothes.

Thus, the invention may provide a method in a computer system for creating a digital model of a person based on a picture and/or scan of the person. The method may include scanning a picture representing the image of a person or the person themselves; preparing a head portion of the picture which may be outlined by an adjustable curve showing around the head; resizing a standard body image according to a body shape parameter selected by the user, which the standard body image may be an image previously stored in the computer system; colorizing the body by using a sampled skin color from the head portion; merging the resized body and the head portion together.

Using the created virtual model described above, the present invention may allow a user to compare and select apparel. The present invention may automatically select and display images of apparel on the virtual model, with each image dressed differently and representing a composite image generated in the system by merging the model and apparel items together. Such a composite image may provide a viewing of the virtual model wearing several items of apparel from a variety of different categories simultaneously. For example, a user may iteratively select an apparel item in a category (e.g. pants), select a hairstyle or a lipstick; manually position or allow the present invention to calculate the position of the selected item(s) in accordance with typical wear positions. Further, the user may change the attributes and layouts of selected item(s) as would be apparent to those skilled in the art.

The herein described systems and methods can be implemented using a wide variety of computing and communication environments, including both wired and wireless telephone and/or computer network environments. The various techniques described herein may be implemented in hardware alone or hardware combined with software. Preferably, the herein described systems and methods are implemented using one or more programmable computing systems that can access one or more communications networks and includes one or more processors, storage mediums storing instructions readable by the processors to cause the computing system to do work, at least one input device, and at least one output device. Computing hardware logic cooperating with various instruction sets are applied to data to perform the functions described herein and to generate output information. The output information is applied to one or more output devices. Programs used by the exemplary computing hardware may be implemented using one or more programming languages, including high level procedural or object oriented programming languages, assembly or machine languages, and/or compiled or interpreted languages. Each such computer program is preferably stored on a storage medium or device (e.g., solid state memory or optical or magnetic disk) that is readable by a general or special purpose programmable computer for configuring and operating the computer when the storage medium or device is read by the computer to perform the procedures described herein. Implementation apparatus may also include a computer-readable storage medium, configured with a computer program, where the storage medium so configured causes a computer to operate in a specific and predefined manner.

The various illustrative logic, logical blocks, modules, data stores, applications, and engines, described in connection with the embodiments disclosed herein may be implemented or performed using one or more of a general purpose processor, a digital signal processor (DSP), an application specific integrated circuit (ASIC), a field programmable gate array (FPGA) or other programmable logic device, discrete gate or transistor devices, discrete hardware components, or any combination thereof, able to perform the functions described herein. A general-purpose processor may include a microprocessor, or may include any other type of conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions described in connection with the features disclosed herein may be embodied directly in hardware, in a software module executed by a processor, or in a combination of the two. A software module may reside in RAM memory, flash memory, ROM memory, EPROM memory, EEPROM memory, registers, a hard disk, a removable drive, a CD-ROM, or any other form of storage medium known in the art. An exemplary storage medium may be coupled to the processor, such that the processor can read information from the storage medium. Alternatively, the storage medium may be integral to the processor. Further, in some aspects, the processor and the storage medium may reside in an ASIC. Alternatively, the processor and the storage medium may reside as discrete components. Additionally, in some aspects, the steps and/or actions of a method or algorithm may reside as one or any combination or set of instructions stored on a machine readable storage medium and/or a computer readable storage medium.

Those of skill in the art will appreciate that the herein described systems and methods are susceptible to various modifications and alternative constructions. There is no intention to limit the scope of the appended claims to the specific constructions described herein. Rather, the herein described systems and methods are intended to cover all modifications, alternative constructions, and equivalents falling within the scope and spirit of the appended claims and their equivalents.

1-4. (canceled)

5. A passive demographic measurement apparatus comprising:
a communication interface configured to communicate with at least one sensor;
a network interface configured to provide communication with one or more remote devices via a network;
data storage configured to store at least one of profile information, sensed data, age, gender, messaging instructions, and control instructions; and
a processor configured to combine sensor data from the at least one sensor with viewing measurements indicative of program content and to send combined data to the one or more remote devices via the network interface.

6. The apparatus of claim 5, wherein the processor is further configured to identify an individual by comparing data received from the at least one sensor with profile information stored in the data storage, and
wherein the processor is further configured to correlate data received from the at least one sensor with profile information stored in the data storage if a match is found.

7. The apparatus of claim 6, wherein the processor is further configured to cooperate with one or more automation devices to adjust environmental settings based on the identification of an individual.

8. The apparatus of claim 5, wherein the at least one sensor includes one or more cameras.

9. The apparatus of claim 5, wherein the program content is television program content.

10. The apparatus of claim 5, wherein the processor is further configured to combine data received from the at least one sensor with data from a security system to identify the presence of unknown individuals and further to notify security personnel or sound an alarm if an unauthorized or unknown individual is detected.

11. The apparatus of claim 5, wherein the processor is further configured to analyze data received from the at least one sensor to determine the presence of a medical emergency and configured to notify healthcare personnel or sound an alarm if a medical emergency is detected.

12. The apparatus of claim 6, wherein the processor is further configured to present an individual an opportunity to create a profile or an opportunity link to an existing profile if no match is found.

13. The apparatus of claim 5, wherein the sensor is included in a communication interface configured to allow the mobile sensor apparatus to communicate with other devices via a network.

14. The apparatus of claim 5, wherein the processor is configured to receive the viewing measurements indicative of program content from at least one of a cable box, a satellite box, a gaming console, and a video streaming console.

15. The apparatus of claim 5, wherein the processor is further configured to combine the sensor data with geographic information.

16. The apparatus of claim 5, wherein the sensor is a mobile device and the processor is further configured such that a movement of the sensor can be to controlled remotely by a user.

17. The apparatus of claim 5, wherein the processor is further configured to generate and display a 3D rendering of an object.

18. The apparatus of claim 17, wherein the processor is further configured to facilitate the purchase of items placed on or within the 3D rendering.

19. A method of collecting and using sensed data, comprising:
receiving data from a sensor;
identifying an individual by comparing the data received from the sensor with stored profile information;
combining the data received from the sensor with viewing measurements indicative of program content from an additional source; and
sending the combined data to a remote device via a network.

20. The method of claim 19, wherein during the sending step the combined data is sent to an automation device configured to adjust environmental settings based on the identified individual.

21. The method of claim 19, further comprising:
correlating the recorded data with a user profile.

22. The method of claim 19, wherein the sensor includes a at least one camera.

23. The method of claim 19, wherein the program content is television program content.

24. The method of claim 19, further comprising:
sounding an alarm or alerting security personnel if the individual cannot be identified.

25. The method of claim 19, further comprising:
analyzing the data received from the sensor to determine the existence of a medical emergency; and notifying healthcare personnel or sounding an alarm if a medical emergency is determined to exist.

26. The method of claim 19, wherein the measurements indicative of program content are received from at least one of a cable box, a satellite box, a gaming console, and a video streaming console.

27. The method of claim 19, further comprising using the combined data to determine the demographic information of viewers.
